(19) United States
(12) Patent Application Publication
(10) Pub. No.: US 2026/0252613 A1
(43) Pub. Date: Aug. 27, 2026

(54) ONTOLOGY-BASED INSIGHTS FOR CONTACT CENTER OPERATIONS

(71) Applicant: NICE LTD., Ra'anana (IL)

(72) Inventors: Shubham BHOJANE, Pune (IN); Ronak KHARADKAR, Pune (IN); Lakhan RATHI, Pune (IN)

(21) Appl. No.: 19/061,561

(22) Filed: Feb. 24, 2025

(51) Int. Cl. G06F 16/34; G06F 40/205

(52) U.S. Cl. CPC G06F 16/345; G06F 40/205

(57) ABSTRACT

A system is adapted to automatically provide ontology-based insights. The system includes a contact center supervisor computing device configured to: over a first period of time, with a database, receive a plurality of interactions between a group of agents and a group of customers on a number of different channels; convert the interactions to a first Ontology Web Language (OWL) file; with the first OWL file, train a large language model (LLM) to extract metrics related to the interactions and metrics related to the agents; with the GUI, at a time later than the first period of time, receive a user input; with a parser, based on the user input and the plurality of interactions, generate a second OWL file; with a visual representation module, graphically represent the second OWL file via the GUI; or with the LLM, generate and display a text summary of the second OWL file.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The subject matter described herein relates to a devices, systems, and methods for enhancing operations with ontology-based insights. This ontology-based insight generation system has particular, but not exclusive, utility for contact centers.

### BACKGROUND

Contact center supervisors use a dashboard to assess agent status and capabilities, and to plan resource allocation. However, existing supervisor dashboards do not display aggregated data from all past interactions. Rather, the interactions dashboard presents interactions filtered by skill or team, but lacks the capability to analyze data from past interactions to obtain broader insights. Current supervisor dashboards focus on skill-specific and/or agent-specific live monitoring of current interactions with Real-Time Interaction Guidance (RTIG), yet fail to incorporate insights derived from previous interactions that could be beneficial for ongoing calls. Thus, there are no analyses or conclusions drawn from the entirety of historical interactions. This results in a lack of comprehensive insights that could inform and improve ongoing interactions and overall decision making.

Another problem is limited contextual understanding. Currently, by dealing with isolated data points, the system may miss the broader context or relationships between different interactions. This lack of context can result in incomplete or misleading analyses, thus reducing the effectiveness of decision-making processes. Challenges also exist in identifying patterns and trends. Currently, representations focused on individual interaction make it challenging to spot emerging patterns or trends that require an aggregated view. Thus, important trends may go unnoticed, leading to missed opportunities or delayed responses to critical issues. This can also lead to inefficient resource allocation. Without aggregated data, resource allocation decisions may be based on incomplete information, thus leading suboptimal resource management and inefficiencies in addressing key issues.

Accordingly, a need exists for improved contact center supervisor dashboards that address these and other issues.

The information included in this Background section of the specification, including any references cited herein and any description or discussion thereof, is included for technical reference purposes only and is not to be regarded as subject matter by which the scope of the disclosure is to be bound.

### SUMMARY

Disclosed is an ontology-based insight generation system, which interactively presents summary information to a contact center supervisor in novel ways, by representing interaction data between agents and customers in Ontology Web Language (OWL), and training a large language model (LLM) to extract metrics from the OWL data. With a graphical user interface (GUI), the system receives a prompt from the supervisor which is sent to the LLM, which generates an output OWL file. The output OWL file can then be summarized in natural language (e.g., English) and/or graphically represented. The insights thus provided to the supervisor can facilitate situational awareness and aid in decision making.

The ontology-based insight generation system disclosed herein has particular, but not exclusive, utility for contact centers.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system adapted to automatically provide ontology-based insights. The system includes a contact center supervisor computing device having a processor and a non-transitory computer-readable medium operably coupled thereto. The contact center supervisor computing device may include a graphical user interface (GUI), and the computer-readable medium may include a plurality of instructions stored in association therewith that are accessible to, and executable by, the processor, to perform operations.

The operations may include: over a first period of time, with a database, receiving a plurality of interactions between a plurality of agents and a plurality of customers, each interaction including a channel of a plurality of channels; converting the plurality of interactions to a first ontology web language (OWL) file; with the first OWL file, training a large language model (LLM) to extract a plurality of metrics related to the interactions and a plurality of metrics related to the agents; with the GUI, at a time later than the first period of time, receiving a user input; with a parser, based on the user input and the plurality of interactions, generating a second OWL file; with a visual representation module, graphically representing the second OWL file via the GUI; or with the LLM, generating a text summary of the second OWL file; and presenting the text summary to the user via the GUI. Other embodiments of this aspect include corresponding computer systems, apparatus, and computer programs recorded on one or more computer storage devices, each configured to perform the actions of the methods.

Implementations may include one or more of the following features. In some embodiments, the user input may include a request for information about a particular agent of the plurality of agents. In some embodiments, the user input may include a request for information about a particular interaction of the plurality of interactions. In some embodiments, the user input may include a request for information about a particular metric related to the interactions. In some embodiments, the user input may include a request for information about a particular metric related to the agents. In some embodiments, the metrics related to the interactions include at least one of a customer beginning sentiment, a customer ending sentiment, a customer frustration, a resolution, a resolution speed, or a customer satisfaction. In some embodiments, the metrics related to the agents include at least one of agent skills, agent wait times, or agent metrics. In some embodiments, if a metric of the plurality of metrics related to an agent of the plurality of agents is below a threshold value for a particular channel of the plurality of channels: providing feedback or training to the agent via the LLM and the GUI; or limiting future interactions for that channel to that agent. In some embodiments, if a metric of the plurality of metrics related to an agent of the plurality of agents is equal to or above a threshold value for a particular channel of the plurality of channels, assigning future interactions for that channel to the agent. In some embodiments, the text summary or the graphically represented second OWL file includes a prediction of agent performance. Implementations of the described techniques may include hardware, a method or process, or computer software on a computer-accessible medium.

One general aspect includes a computer-implemented method. The computer-implemented method includes: with contact center supervisor computing device having a processor and a non-transitory computer-readable medium operably coupled thereto, the contact center supervisor computing device including a graphical user interface (GUI), the computer-readable medium including a plurality of instructions stored in association therewith that are accessible to, and executable by, the processor: over a first period of time, with a database, receiving a plurality of interactions between a plurality of agents and a plurality of customers, each interaction may include a channel of a plurality of channels; converting the plurality of interactions to a first ontology web language (OWL) file; with the first OWL file, training a large language model (LLM) to extract a plurality of metrics related to the interactions and a plurality of metrics related to the agents; with the GUI, at a time later than the first period of time, receiving a user input; with a parser, based on the user input and the plurality of interactions, generating a second OWL file; with a visual representation module, graphically representing the second OWL file via the GUI; or with the LLM, generating a text summary of the second OWL file; and presenting the text summary to the user via the GUI. Other embodiments of this aspect include corresponding computer systems, apparatus, and computer programs recorded on one or more computer storage devices, each configured to perform the actions of the methods.

Implementations may include one or more of the following features. In some embodiments, the user input may include a request for information about a particular agent of the plurality of agents. In some embodiments, the user input may include a request for information about a particular interaction of the plurality of interactions. In some embodiments, the user input may include a request for information about a particular metric related to the interactions. In some embodiments, the user input may include a request for information about a particular metric related to the agents. In some embodiments, the metrics related to the interactions include at least one of a customer beginning sentiment, a customer ending sentiment, a customer frustration, a resolution, a resolution speed, or a customer satisfaction. In some embodiments, the metrics related to the agents include at least one of agent skills, agent wait times, or agent metrics. In some embodiments, if a metric of the plurality of metrics related to an agent of the plurality of agents is below a threshold value for a particular channel of the plurality of channels: providing feedback or training to the agent via the LLM and the GUI; or limiting future interactions for that channel to that agent. In some embodiments, if a metric of the plurality of metrics related to an agent of the plurality of agents is equal to or above a threshold value for a particular channel of the plurality of channels, assigning future interactions for that channel to the agent. In some embodiments, the text summary or the graphically represented second OWL file includes a prediction of agent performance. Implementations of the described techniques may include hardware, a method or process, or computer software on a computer-accessible medium.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the ontology-based insight generation system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a schematic, diagrammatic representation, in block diagram form, of a contact center, in accordance with at least one embodiment of the present disclosure.

FIG. 2 is a schematic, diagrammatic representation, in block diagram form, of an example contact center supervisor computing architecture equipped with the ontology-based insight generation system, in accordance with at least one embodiment of the present disclosure.

FIG. 3 is a schematic, diagrammatic representation, in block diagram form, of an example ontology-based insight generation system in inference mode, in accordance with at least one embodiment of the present disclosure.

FIG. 4 is a schematic, diagrammatic representation, in flow diagram form, of an example ontology-based insight generation training method, in accordance with at least one embodiment of the present disclosure.

FIG. 5 is a schematic, diagrammatic representation, in flow diagram form, of an example ontology-based insight generation training method, in accordance with at least one embodiment of the present disclosure.

FIG. 6 is a schematic, diagrammatic representation, in flow diagram form, of an example ontology-based insight generation training method, in accordance with at least one embodiment of the present disclosure.

FIG. 7 is a schematic, diagrammatic representation, in flow diagram form, of an example ontology-based insight generation method for a chat channel, in accordance with at least one embodiment of the present disclosure.

FIG. 8 is a schematic, diagrammatic representation, in flow diagram form, of an example ontology-based insight generation method for a voice call channel, in accordance with at least one embodiment of the present disclosure.

FIG. 9 is a schematic, diagrammatic representation, in flow diagram form, of an example ontology-based insight generation method, in accordance with at least one embodiment of the present disclosure.

FIG. 10 is a schematic, diagrammatic representation, in flow diagram form, of an example ontology-based insight generation method, in accordance with at least one embodiment of the present disclosure.

FIG. 11 is an example supervisor dashboard screen display for an ontology-based insight generation system, in accordance with at least one embodiment of the present disclosure.

FIG. 12 is an example ontology-enhanced supervisor dashboard screen display for an ontology-based insight generation system, in accordance with at least one embodiment of the present disclosure.

FIG. 13 is an example ontology-enhanced supervisor dashboard screen display for an ontology-based insight generation system, in accordance with at least one embodiment of the present disclosure.

FIG. 14 is an example ontology-enhanced supervisor dashboard screen display for an ontology-based insight generation system, in accordance with at least one embodiment of the present disclosure.

FIG. 15 is an example ontology-enhanced supervisor dashboard screen display for an ontology-based insight generation system, in accordance with at least one embodiment of the present disclosure.

FIG. 16 is an example ontology-enhanced supervisor dashboard screen display for an ontology-based insight generation system, in accordance with at least one embodiment of the present disclosure.

FIG. 17 is an example ontology-enhanced supervisor dashboard screen display for an ontology-based insight generation system, in accordance with at least one embodiment of the present disclosure.

FIG. 18 is a schematic diagram of a processor circuit, in accordance with at least one embodiment of the present disclosure.

### DETAILED DESCRIPTION

In accordance with at least one embodiment of the present disclosure, an ontology-based insight generation system is provided which interactively presents summary information to a contact center supervisor in novel ways.

To address the lack of comprehensive analysis of past interactions in existing supervisor dashboards, the present disclosure creates an enhanced interactions dashboard. This new dashboard aims to aggregate and analyze data from a portion of past interactions, preferably all or substantially all past interactions, providing a holistic view that enables the extraction of valuable insights.

Ontologies are a formal way to describe taxonomies and classification trees, by defining the structured information for various domains, with nouns representing classes of objects and verbs representing relationships between the objects. Ontology provides a structured framework for representing knowledge about a domain. Ontologies are thus used to capture and organize knowledge in a way that can be understood and interpreted by both humans and machines, by defining concepts, their properties, and the relationships between them within a specific domain or area of interest.

Ontology Web Language (OWL) is a semantic markup language that allows for the formal definition and representation of ontologies. OWL is based on description logic and provides a rich set of constructs to define classes, properties, and relationships between them. It is designed to be used by applications that need to process the content of information instead of just presenting raw information to humans.

Integration of ontologies with large language models (LLMs) provides numerous benefits. The concepts derived from ontology and validated knowledge are used to train custom LLMs that are tailored for contact centers, thus enhancing supervisor prompts. This customization allows LLMs to produce more precise and contextually relevant responses to user queries, and helps address the problem of “hallucinations”—a common challenge for LLMs—particularly in relation to supervisor queries about agent placement and performance.

Ontology can be integrated into contact centers to yield knowledge-driven results. Currently, supervisors guide agents based on their expertise, experience, and sentiment analysis. With the enhanced dashboard provided in the present disclosure, supervisors will also have structured and pattern-based knowledge analysis of past interactions for better resolution. The supervisor can thus more efficiently and/or more accurately uncover hidden insights through logical entailments, thus aiding the contact center's business growth-insights that might not be apparent by merely examining the data manually or by a conventional dashboard displaying only a limited set of past data or by not providing such insights to facilitate an ongoing customer contact.

These insights can aid in efficient resource allocation. For example, supervisors can use the ontological dashboard enhancements to identify agents who excel at efficiently handling customer sentiments and interactions. This list of agents can be utilized for future interactions when the supervisor is busy and requires intervention. In such cases, the supervisor can assign one of the agents from this list to manage the interaction in their place.

Ontological insights can also improve agent performance. Supervisors can assist agents in improving their understanding and performance in areas where they are lacking, such as effective questioning, empathy, demonstrating ownership, uncovering needs, making connections, and overall customer satisfaction. These insights can be viewed on the enhanced dashboard, ultimately benefiting the contact center business.

Reducing hallucination in LLMs is another benefit of the present disclosure. Without OWL data, LLM models can only assess agent performance based on specific traits, metrics, channels, and sentiments. Conversely, with OWL data, the LLM can understand trait interactions (e.g., how Empathy and Patience influence performance), query relationships (e.g., which agents excel in different Channel Types) and analyze how trait levels impact customer satisfaction.

Such ontological insights can also lead to improved chatbot intelligence. New or previously hidden trends and patterns, identified through the ontology-based dashboard, can serve as valuable knowledge for automated channels like chatbots. Integrating this historical data into the knowledge base enhances the intelligence of chatbots, enabling them to provide more timely and more accurate and relevant responses to customers, when a live agent is unavailable or not desired.

Interactions data collection begins with importing data, e.g., extracting interaction details from, e.g., Snowflake and DataLake using SQL queries or file reading tools. The extracted data is then loaded into DataFrames using libraries like Pandas for Snowflake or Spark for DataLake. DataFrames can then be merged if interactions, traits, and metrics are in separate tables/files, to create a unified dataset. The system then cleans and normalizes the combined DataFrame to ensure consistency and readiness for further analysis.

OWL parsing then divides the data into classes:
Agent: Represents entities or individuals that interact with each other.
Interactions: Refers to the actions or relationships between agents.
Trait: Characteristics or attributes of agents.
Metric: Quantitative measures used to evaluate interactions or traits.

### Properties:

hasInteraction With: A property linking agents to their interactions.
exhibitsTrait: A property linking agents to the traits they exhibit.

Next, the system preprocesses the data for training. Removing errors involves identifying and correcting inaccuracies or corrupt data entries. Handling inconsistencies involves standardizing data formats and resolving discrepancies across different data sources. Duplicate records are also eliminated, to avoid redundant information. Data is then normalized into a consistent format, such as standardizing date formats or scaling numerical values, and adjusting data ranges or values to ensure consistency and comparability.

Next, the system designs and creates prompts by, for example, formulating questions or statements that guide the LLM to learn the relationships between interactions, traits, and metrics. An example prompt may be: “Describe how Agent A interacts with Agent B and what traits are associated with these interactions.”

Next, the system trains the LLM, by setting up the training parameters such as learning rate, batch size, and number of epochs. The OWL ontology data is then incorporated into the training process, to ensure the model learns the relationships and properties defined in the ontology. The system keeps track of the training progress, checking metrics like loss and accuracy to ensure the model is learning correctly.

Next, the system evaluates and integrates the LLM. A qualitative review assesses the model's outputs to ensure they are meaningful and accurate based on human judgment and domain knowledge. The system then verifies that the model's understanding and outputs are consistent with the OWL data and ontology definitions. Integration involves deploying the trained LLM into a production environment or integrating it with existing systems where it is used for practical applications.

Next, the system continuously tracks the model's performance in real-world scenarios, to ensure it meets the desired standards and goals.

Here is some example data:

TABLE 1
Processed DataFrame with Logical Entailment and OWL Mappings

| agent_id | interaction_id | trait | metric | hasInteractionWith |
|---|---|---|---|---|
| 1 | 101 | positive | 0.8 | 101 |
| 2 | 102 | negative | 0.2 | 102 |
| 1 | 103 | neutral | 0.5 | 103 |
| 3 | 104 | positive | 0.7 | 104 |

TABLE 2
Trait to Performance Mapping

| exhibitsTrait | performance_category | hasPerformanceCategory |
|---|---|---|
| positive | high performer | high performer |
| negative | low performer | low performer |
| neutral | moderate performer | moderate performer |
| positive | high performer | high performer |

In this case, an example insight might be:

### Conceptual Relations and Overlaps

Agent 1 and Agent 3 have a shared trait.
Agent 1 and Agent 3 have a similar performance.

Here is some example code to execute the method described above:

```
# Install necessary libraries
!pip install rdflib transformers torch pandas
# Step 1: Data Preparation
import pandas as pd
# Load interaction data
data = {
  ‘agent_id’: [1, 2, 1, 3],
  ‘interaction_id’: [101, 102, 103, 104],
  ‘trait’: [‘positive’, ‘negative’, ‘neutral’, ‘positive’],
  ‘metric’: [0.8, 0.2, 0.5, 0.7]
}
df = pd.DataFrame(data)
# Step 2: OWL Parsing and Data Extraction
from rdflib import Graph, URIRef, Literal
from rdflib.namespace import RDF, RDFS, OWL
# Create a simple OWL graph
g = Graph( )
agent = URIRef(“http://nice.org/Agent”)
interaction = URIRef(“http://nice.org/Interaction”)
trait = URIRef(“http://nice.org/Trait”)
metric = URIRef(“http://nice.org/Metric”)
performance_category = URIRef(“http://nice.org/PerformanceCategory”)
g.add((agent, RDF.type, OWL.Class))
g.add((interaction, RDF.type, OWL.Class))
g.add((trait, RDF.type, OWL.Class))
g.add((metric, RDF.type, OWL.Class))
g.add((performance_category, RDF.type, OWL.Class))
# Define properties
hasInteractionWith = URIRef(“http://nice.org/hasInteractionWith”)
exhibitsTrait = URIRef(“http://nice.org/exhibitsTrait”)
hasPerformanceCategory = URIRef(“http://nice.org/hasPerformanceCategory”)
g.add((hasInteractionWith, RDF.type, OWL.ObjectProperty))
g.add((exhibitsTrait, RDF.type, OWL.ObjectProperty))
g.add((hasPerformanceCategory, RDF.type, OWL.ObjectProperty))
# Serialize and parse OWL data
owl_data = g.serialize(format=“turtle”)
g.parse(data=owl_data, format=“turtle”)
# Step 3: Preprocess Data
# Map data columns to OWL classes/properties
df[‘hasInteractionWith’] = df[‘interaction_id’]
df[‘exhibitsTrait’] = df[‘trait’]
# Logical entailment: Classify performance based on rules
def classify_performance(row):
  if row[‘exhibitsTrait’] == ‘positive’ and row[‘metric’] > 0.6:
    return ‘high performer’
  elif row[‘exhibitsTrait’] == ‘negative’ or row[‘metric’] < 0.4:
    return ‘low performer’
  elif row[‘exhibitsTrait’] == ‘neutral’ and 0.4 <= row[‘metric’] <= 0.6:
    return ‘moderate performer’
  else:
    return ‘unclassified’
df[‘performance_category’] = df.apply(classify_performance, axis=1)
df[‘hasPerformanceCategory’] = df[‘performance_category’]
tokenizer = DistilBertTokenizer.from_pretrained(‘distilbert-base-uncased’)
class InteractionDataset(Dataset):
  def _{——}init_{——}(self, texts, labels):
    self.encodings = tokenizer(texts, truncation=True, padding=True, max_length=128)
    self.labels = labels
  def _{——}getitem_{——}(self, idx):
    item = {key: torch.tensor(val[idx]) for key, val in self.encodings.items( )}
    item[‘labels’] = torch.tensor(self.labels[idx])
    return item
  def _{——}len_{——}(self):
    return len(self.labels)
texts = df[‘exhibitsTrait’].tolist( )
labels = [1 if metric > 0.5 else 0 for metric in df[‘metric’]]
dataset = InteractionDataset(texts, labels)
model = DistilBertForSequenceClassification.from_pretrained(‘distilbert-base-uncased’,
num_labels=2)
training_args = TrainingArguments(
  output_dir=‘./results’,
  per_device_train_batch_size=2,
  num_train_epochs=2,
  logging_dir=‘./logs’,
)
trainer = Trainer(
  model=model,
  args=training_args,
  train_dataset=dataset,
  eval_dataset=dataset # Use the same dataset for evaluation
)
# Train the model
trainer.train( )
```

The resulting impact on other Contact Center systems can include automated actions such as training recommendations, which may include training on emotion control and aggression management to handle negative sentiment in chats, or channel-specific knowledge enhancement to improve chat handling skills. Task allocation adjustments may include assigning high-priority calls to agents with a proven track record of success in the call channel, and/or limiting the allocation of chat interactions with negative sentiment until the agent's skills improve. Performance monitoring and feedback may include setting up key performance indicators for required channel improvement (e.g., conversion rate from negative to positive sentiment). Optimized scheduling (e.g., workforce management) impacts may include assigning agents with a proven track records to handle call-heavy shifts to maximize positive customer outcomes, and allocating time for training and lower-stress interactions in particular channels during low-demand periods.

The present disclosure aids substantially in call center agent supervision, by improving the situational awareness of supervisors. Implemented on a supervisor workstation in communication with an interactions database and a large language model (LLM), the ontology-based insight generation system disclosed herein provides practical, real-time or near-real time guidance to supervisors regarding the performance of agents. This augmented user interface transforms masses of raw interaction data into actionable insights and recommendations, with greater accuracy than human-generated insights, and without the normally routine need to spend hours manually sifting through even a fraction of available data. This unconventional approach improves the functioning of the contact center supervisor computing system, by reducing the amount of time spent analyzing interaction data, even while increasing the amount of data analyzed, thus reducing energy consumption and the greenhouse gas emissions associated therewith.

The ontology-based insight generation system may be implemented as a process at least partly viewable on a display, and operated by a control process executing on a processor that accepts user inputs from a keyboard, mouse, or touchscreen interface, and that is in communication with one or more interaction databases. In that regard, the control process performs certain specific operations in response to different inputs or selections made at different times. Outputs of the ontology-based insight generation system may be printed, shown on a display, or otherwise communicated to human operators. Certain structures, functions, and operations of the processor, display, sensors, and user input systems are known in the art, while others are recited herein to enable novel features or aspects of the present disclosure with particularity.

These descriptions are provided for exemplary purposes only, and should not be considered to limit the scope of the ontology-based insight generation system. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one of ordinary skill in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

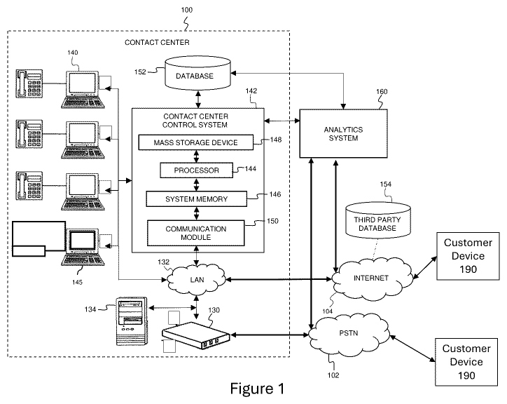

FIG. 1 is a schematic, diagrammatic representation, in block diagram form, of a contact center 100, in accordance with at least one embodiment of the present disclosure. The term “call center” or “contact center,” as used herein, can include any facility or system server suitable for receiving and recording electronic communications between agents and customers. Such contacts, interactions, or communications can include, for example, telephone calls, chats, facsimile transmissions, e-mails, web interactions, voice over IP (“VoIP”) and video. Various specific types of communications contemplated through one or more of these channels include, without limitation, email, SMS data (e.g., text), tweet, instant message, web-form submission, smartphone app, social media data, and web content data (including but not limited to internet survey data, blog data, microblog data, discussion forum data, and chat data), etc. Thus, as used herein, the term “call” (including “end-of-call” and similar uses) may refer to any of these types of ongoing real-time communications between a customer and an agent. Typically, call references a phone call, chat or DM, texting, or interactive discussion by phone, app, video, or exchanged versions of the foregoing. In some embodiments, the communications can include contact tasks, such as taking an order, making a sale, responding to a complaint, etc. In various aspects, real-time communication, such as voice, video, or both, is preferably included. It is contemplated that these communications may be transmitted by and through any type of telecommunication device and over any medium suitable for carrying data. For example, the communications may be transmitted by or through telephone lines, cable, or wireless communications. As shown in FIG. 1, the contact center 100 of the present disclosure is adapted to receive and record varying electronic communications and data formats that represent an interaction that may occur between a customer device 190 and a contact center agent computing device 140 during fulfillment of a customer and agent transaction. In one embodiment, the contact center 100 records all of the customer calls in uncompressed audio formats. In the illustrated embodiment, customers may communicate with agents associated with the contact center 100 via multiple different communication networks such as a public switched telephone network (PSTN) 102 or the Internet 104. For example, a customer may initiate an interaction session through a customer device 190, which may be or include a traditional telephone, a fax machine, a cellular (e.g., mobile) telephone, a personal computing device with a modem, or other legacy communication device via the PSTN 102. Further, the contact center 100 may accept internet-based interaction sessions from personal computing devices, VoIP telephones, and internet-enabled smartphones and personal digital assistants (PDAs).

A contact center supervisor computing device 145 communicates via the LAN 132 with the contact center control system 142 and the analytics system 160. The supervisor computing device 145 may have access to records and statistics regarding interactions between the agent computing devices 140 and the customer devices 190.

As one of ordinary skill in the art would recognize, the illustrated example of communication channels associated with a contact center 100 in FIG. 1 is just an example, and the contact center may accept contact interactions, and other analyzed interaction information and/or routing recommendations from an analytics center, through various additional and/or different devices and communication channels whether or not expressly described herein.

For example, in some embodiments, internet-based interactions and/or telephone-based interactions may be routed through an analytics system 160 before reaching the contact center 100 or may be routed simultaneously to the contact center and the analytics center (or even directly and only to the contact center). Also, in some embodiments, internet-based interactions may be received and handled by a marketing department associated with either the contact center 100 or analytics center 120. The analytics system 160 may be controlled by the same entity or a different entity than the contact center 100. Further, the analytics system 160 may be a part of, or independent of, the contact center 100, and may be in direct or indirect communication with the database 152, contact center control computer 142, etc.

The contact center 100 may include a contact center control system or contact center control computer 142 in communication with a local database 152. The contact center control computer 142 may include a mass storage device 148, a processor 144, a system memory 146, and a communication module 150, in communication via a local area network (LAN) 132 with a switch or router 130 capable of accessing a local server 134 and/or the Internet 104 or PSTN 102. Via the internet 104, the contact center control computer 142 may contact a third-party database 154.

Before continuing, it should be noted that the examples described above are provided for purposes of illustration, and are not intended to be limiting. Other devices and/or device configurations may be utilized to carry out the operations described herein. Block diagrams are provided herein for exemplary purposes; a person of ordinary skill in the art will recognize myriad variations that nonetheless fall within the scope of the present disclosure. For example, any of the blocks described herein may optionally include an output to a user of information relevant to the block, and may thus represent an improvement in the user interface over existing art by providing information (whether static or dynamically updated) that is not otherwise available.

Similarly, block diagrams may show a particular arrangement of components, modules, services, steps, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein.

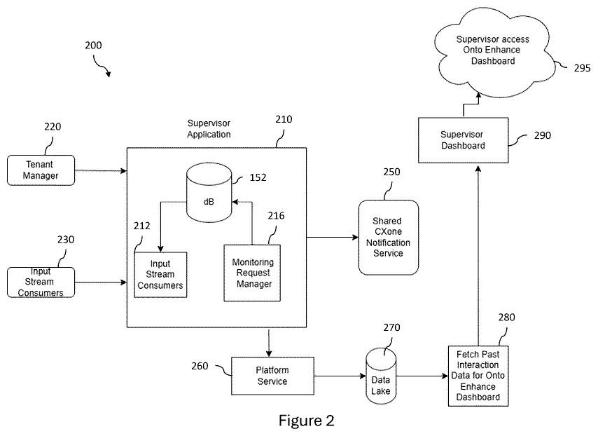

FIG. 2 is a schematic, diagrammatic representation, in block diagram form, of an example contact center supervisor computing architecture 200 equipped with the ontology-based insight generation system, in accordance with at least one embodiment of the present disclosure. In the example shown in FIG. 2, a supervisor application 210 receives data from a tenant manager 220 and from input stream consumers 230. Within the supervisor application 210, input stream consumers 212 receive data from the database 152, which in turn receives data from a monitoring request manager 216. The supervisor application 210 sends data to a shared notification service 250, and also sends data to a platform service 260, which sends data to the data lake 270. A data fetching step 280 fetches past interaction data for the ontology-enhanced dashboard, and passes it to the supervisor dashboard 290 for display, interaction, and querying via the supervisor access ontology-enhanced dashboard 295.

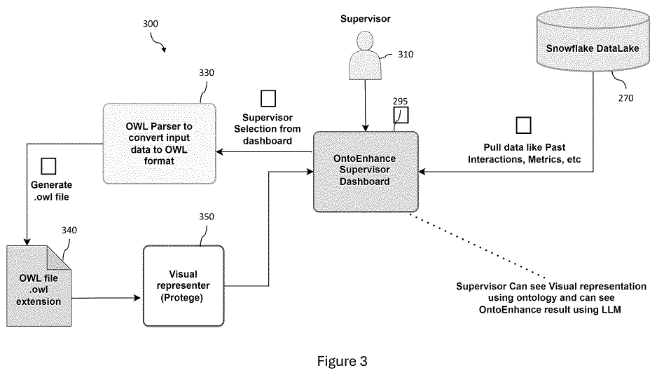

FIG. 3 is a schematic, diagrammatic representation, in block diagram form, of an example ontology-based insight generation system 300 in inference mode, in accordance with at least one embodiment of the present disclosure. In the example shown in FIG. 3, a supervisor or other user 310 interacts with the ontology-enhanced supervisor dashboard 295, which pulls data (e.g., past interactions, metrics, etc.) from the data lake 270. The supervisor's selection or other user input, along with data from the data lake 270, is received by an Ontology Web Language (OWL) parser 330 and converted to an OWL file 340 (e.g., a structured data file with a “.owl” extension), which is then passed to a visual representer or visual representation module 350, which shows a visual or graphical representation of the OWL file on the ontology-enhanced supervisor dashboard 295. Thus, the supervisor 310 can see the visual or graphical representation via the ontology-enhanced dashboard. The supervisor 310 can also see a textual summary of the OWL file generated by the LLM, as described below.

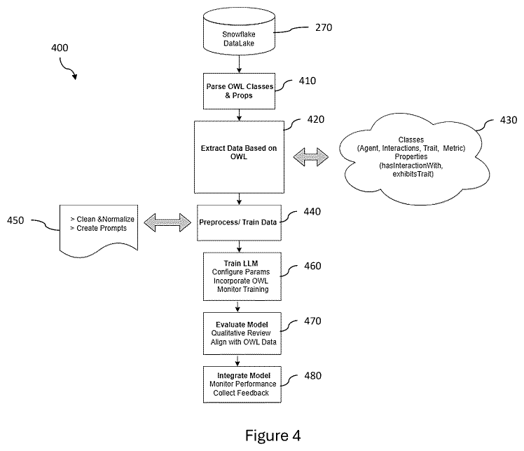

FIG. 4 is a schematic, diagrammatic representation, in flow diagram form, of an example ontology-based insight generation training method 400, in accordance with at least one embodiment of the present disclosure. It is understood that the steps of method 400 may be performed in a different order than shown in FIG. 4, additional steps can be provided before, during, and after the steps, and/or some of the steps described can be replaced or eliminated in other embodiments. One or more of steps of the method 400 can be carried by one or more devices and/or systems described herein, such as components of the system 100, 200, 300, and/or processor circuit 1850.

In step 410, the method 400 includes receiving data from the data lake 270 and parsing it into an OWL format (e.g., OWL classes and properties). Execution then proceeds to step 420.

In step 420, the method 400 includes extracting data 430 based on the OWL format, including classes (e.g., agent interactions, traits, or metrics) and properties (e.g., variables such as hasInteraction With or exhibitsTrait). Execution then proceeds to step 440.

In step 440, the method 400 includes preprocessing the data as LLM training data, including a step 450 wherein the data is cleaned and normalized, and prompts are created. Execution then proceeds to step 460.

In step 460, the method 400 includes training the LLM using the preprocessed OWL data. This includes configuring the training parameters, incorporating the OWL data, and monitoring the training. Execution then proceeds to step 470.

In step 470, the method 400 includes evaluating the trained model, performing a qualitative review, and aligning the model with the OWL data. Execution then proceeds to step 480.

In step 480, the method 400 includes integrating the model with existing contact center supervisor software, monitoring performance of the model, and collecting feedback regarding the performance of the model. The method 400 is now complete.

Flow diagrams are provided herein for exemplary purposes; a person of ordinary skill in the art will recognize myriad variations that nonetheless fall within the scope of the present disclosure. For example, any of the steps described herein may optionally include an output to a user of information relevant to the step, and may thus represent an improvement in the user interface over existing art by providing information (whether static or dynamically updated) that is not otherwise available.

Similarly, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein. For example, when a supervisor or other user issues a query, a result may need to be returned within 2-3 seconds to avoid a sense of lag on the part of the supervisor or user. This may involve calculation by an LLM trained with hundreds of billions of parameters.

It is noted that training the LLM using data in OWL format provides numerous advantages. Enhanced Data Structure and Consistency: The semantic richness of OWL allows LLMs to better understand context, relationships, and dependencies between concepts, which can improve the accuracy and relevance of generated outputs.

Reduces Hallucinations and Misinformation: Structured validation in OWL helps ensure that training data is correct and validated before being used in the model, which reduces the likelihood of generating inaccurate or hallucinated outputs during inference. The logical structure ensures that the LLM's responses adhere to the valid relationships between entities, helping it avoid incorrect or fabricated information.

Facilitates Domain-Specific Knowledge Integration: By training on data in OWL, LLMs can leverage pre-existing knowledge graphs and ontologies, enabling them to generate domain-specific insights more accurately and efficiently.

Improved Reasoning and Inference Capabilities: LLMs trained with OWL data can reason over ontology-based relationships like parent-child hierarchies, associations, and properties, leading to better semantic understanding of queries or requests.

Better Querying and Contextual Understanding: With OWL's use of ontology-based relationships, LLMs can contextualize queries more effectively, enhancing question-answering capabilities. By understanding related concepts and their relationships, LLMs trained on OWL data can return responses that are contextually aware.

These benefits are not found in the existing art.

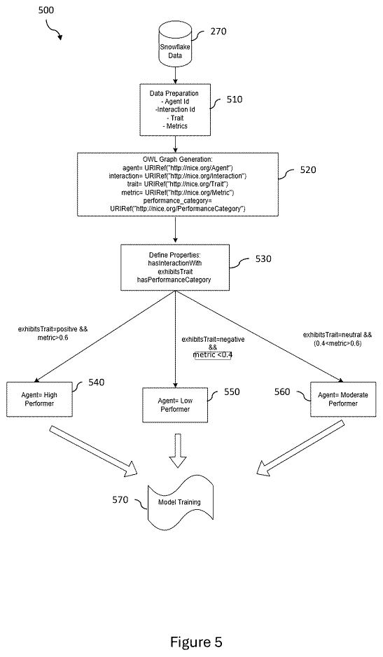

FIG. 5 is a schematic, diagrammatic representation, in flow diagram form, of an example ontology-based insight generation training method 500, in accordance with at least one embodiment of the present disclosure.

In step 510, the method 500 includes preparing the data, such as an agent identification, interaction identification, a trait, and/or performance metrics for the agents or interactions. Execution then proceeds to step 520.

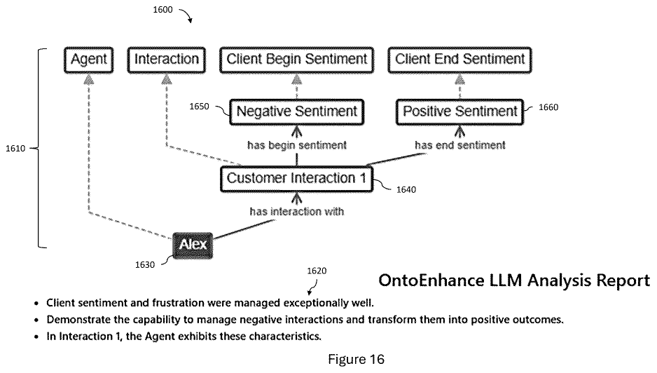

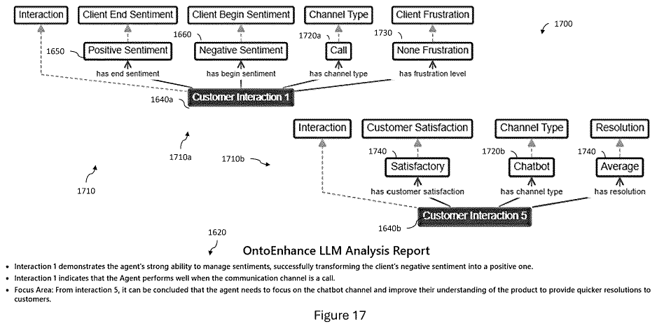

In step 520, the method 500 includes generating an OWL graph, including at least one of an agent, interaction, trait, metric, or performance category. Example OWL graphs are shown below in FIGS. 16 and 17. Execution then proceeds to step 530.

In step 530, the method 500 includes, based on the OWL graph, defining properties such as whether an agent has an interaction with a particular customer, exhibits a particular trait, or has a particular performance category.

If the agent exhibits the particular trait with a metric above a first threshold value, execution proceeds to step 540.

If the agent does not exhibit the trait and has a metric below a second threshold value, execution proceeds to step 550.

If the agent is neutral with regard to the trait and has a metric between the first and second threshold values, execution proceeds to step 560.

In step 540, the agent is labeled as a high performer. Execution then proceeds to step 570.

In step 550, the agent is labeled as a low performer. Execution then proceeds to step 570.

In step 560, the agent is labeled as a moderate performer. Execution then proceeds to step 570.

In step 570, the labels, in OWL format, are used to train the model. The method 500 is now complete. In other embodiments (not shown), it should be understood different thresholds can be set.

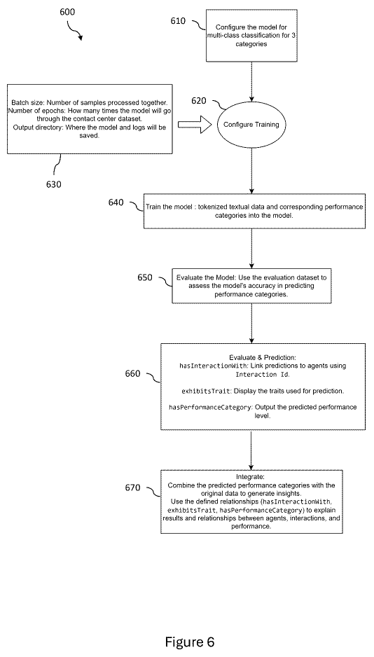

FIG. 6 is a schematic, diagrammatic representation, in flow diagram form, of an example ontology-based insight generation training method 600, in accordance with at least one embodiment of the present disclosure.

In step 610, the method 600 includes configuring the model for multi-class classification of, for example, three categories. Depending on the implementation, the number of classes may be more or less than three. Execution then proceeds to step 620.

In step 620, the method 600 includes configuring the training using training parameters 630. The training parameters include a batch size (the number of samples that will be processed together), a number of epochs (how many times the model will go through the training data), and an output directory where the model and logs will be saved. Execution then proceeds to step 640.

In step 640, the method 600 includes training the model using tokenized textual data and corresponding performance categories, in OWL format. Execution then proceeds to step 650.

In step 650, the method 600 includes evaluating the trained model using an evaluation dataset to assess the model's accuracy in predicting performance categories. Execution then proceeds to step 660.

In step 660, the method 600 includes using the model to evaluate and predict based on live (e.g., real-time) data queries, including for example the interactions, traits, and performance categories for a particular agent. Execution then proceeds to step 670.

In step 670, the method 600 includes integrating the model's predictions with the original OWL data to generate insights, using the defined relationships, interactions, and performance. The method 600 is now complete.

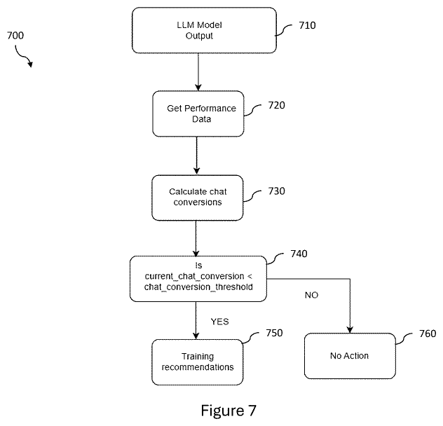

FIG. 7 is a schematic, diagrammatic representation, in flow diagram form, of an example ontology-based insight generation method 700 for a chat channel, in accordance with at least one embodiment of the present disclosure.

In step 710, the method 700 includes receiving the output from the trained LLM based on the OWL query. Execution then proceeds to step 720.

In step 720, the method 700 includes fetching the performance data for the chat channel. Execution then proceeds to step 730.

In step 730, the method 700 includes calculating the number or percentage of chat conversions. This may for example be the number or percentage of chats where the customer sentiment was changed from negative to positive during interaction with the agent(s). Execution then proceeds to step 740.

In step 740, the method 700 includes determining whether the number or percentage of chat conversions is less than a threshold value. If yes, execution proceeds to step 750. If no, execution proceeds to step 760.

In step 750, the method 700 includes recommending training for the agent(s) on the chat channel. For example, if the chat conversion rate is 3%, which is below the 10% threshold, the system may suggest:
Emotion Control: To better understand customer emotions.
Aggression Management: To remain calm in challenging conversations.
Channel-Specific Knowledge: To better handle chat channel intricacies.

The method 700 is now complete.

In step 760, the method 700 includes taking no action regarding training of the agent(s). The method 700 is now complete.

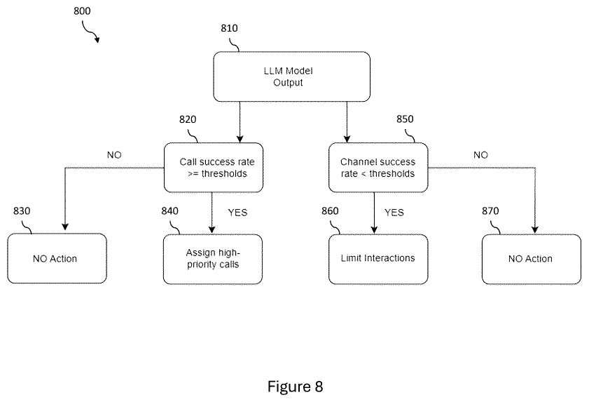

FIG. 8 is a schematic, diagrammatic representation, in flow diagram form, of an example ontology-based insight generation method 800 for a voice call channel, in accordance with at least one embodiment of the present disclosure.

In step 810, the method 800 includes receiving the output from the trained LLM based on the OWL query. Execution then proceeds to steps 820 and 850.

In step 820, the method 800 includes determining whether the call success rate for an agent (e.g., conversion from negative to positive customer sentiment) is greater than or equal to a threshold value. If no, execution proceeds to step 830. If yes, execution proceeds to step 840.

In step 830, the method 800 includes taking no action regarding the assignment of high-priority calls.

In step 840, the method 800 includes assigning high-priority calls to that agent.

In step 850, the method 800 includes determining whether the channel success rate is less than the threshold. If yes, execution proceeds to step 860. If no, execution proceeds to step 870.

In step 860, the method 800 includes limiting interactions for that agent on the voice call channel.

In step 870, the method 800 includes taking no action regarding limiting interactions for that agent. For example, the system may avoid routing negative sentiment calls to that agent until the agent's skills improve.

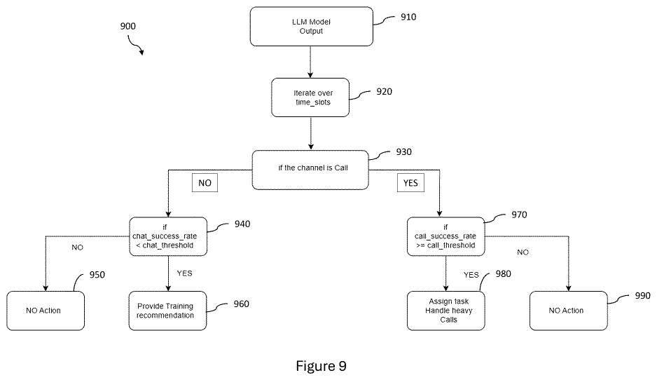

FIG. 9 is a schematic, diagrammatic representation, in flow diagram form, of an example ontology-based insight generation method 900, in accordance with at least one embodiment of the present disclosure.

In step 910, the method 900 includes receiving the LLM output. Execution then proceeds to step 920.

In step 920, the method 900 includes iterating over the available time slots for steps 930-990.

In step 930, the method 900 includes determining whether the channel is voice call. If no, execution proceeds to step 940. If yes, execution proceeds to step 970.

In step 940, the method 900 includes determining whether the chat success rate is less than a threshold value. If no, execution proceeds to step 950. If yes, execution proceeds to step 960.

In step 950, the method 900 includes taking no action.

In step 960, the method 900 includes providing a training recommendation for the agent for that time slot.

In step 970, the method 900 includes determining whether the call success rate is greater than or equal to a threshold value. If yes, execution proceeds to step 980. If no, execution proceeds to step 990.

In step 980, the method 900 includes assigning the agent a task to handle heavy call volume during that time slot.

In step 990, the method 900 includes taking no action.

In an example, given the following time slots:
9 AM-12 PM (high call demand) the output might be to assign the agent to handle calls.
12 PM-3 PM (low chat demand) the output might be to schedule training for empathy and aggression management.

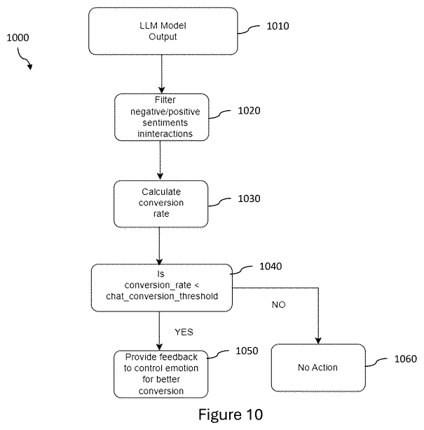

FIG. 10 is a schematic, diagrammatic representation, in flow diagram form, of an example ontology-based insight generation method 1000, in accordance with at least one embodiment of the present disclosure.

In step 1010, the method 1000 includes receiving the output from the LLM. Execution then proceeds to step 1020.

In step 1020, the method 1000 includes filtering negative vs. positive sentiments for the interactions. Execution then proceeds to step 1030.

In step 1030, the method 1000 includes calculating the conversion rate for the interactions. Execution then proceeds to step 1040.

In step 1040, the method 1000 includes determining whether the conversion rate is less than a defined threshold value. If yes, execution proceeds to step 1050. If no, execution proceeds to step 1060.

In step 1050, the method 1000 includes providing feedback to control emotions for better conversion. The method 1000 is now complete.

In step 1060, the method 1000 includes taking no action. The method 1000 is now complete.

In an example, for a set of 10 chat interactions, 6 start with negative sentiment, and only 1 is successfully converted to positive sentiment. The system detects a low conversion rate (16.6%) and provides feedback: “Use empathetic language to build trust with the customer.”

The outcome of these automated actions includes training impact. For example, the agent improves emotion and aggression management for interactions, and gains better handling of channel-specific challenges. The outcomes also include improved task allocation, such that critical calls are handled by the most successful agents, thus maximizing positive outcomes, and negative-start interactions are routed to high-performing agents until the skills of low-performing agents improve. Such feedback loops can accelerate skill acquisition. Another outcome is optimized scheduling (e.g., workforce management), where the agent's schedule aligns with their strengths while incorporating time for development. This ensures maximum utilization of high-performing abilities on contacts, while also providing maximum training opportunities for those who require it.

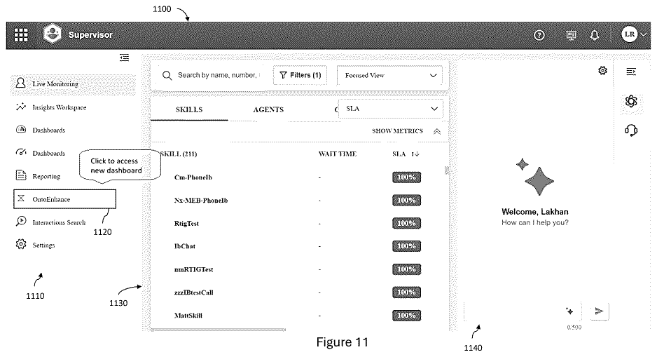

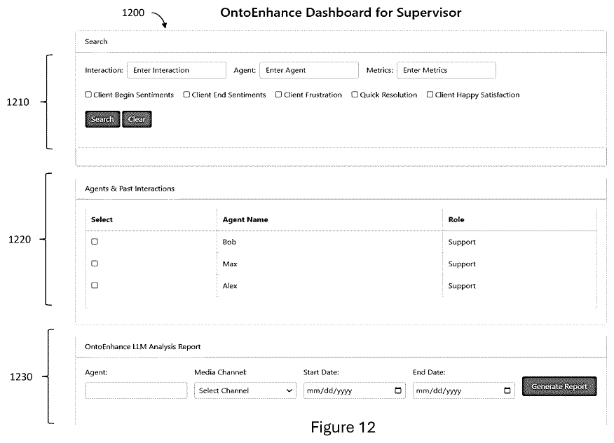

FIG. 11 is an example supervisor dashboard screen display 1100 for an ontology-based insight generation system, in accordance with at least one embodiment of the present disclosure. The dashboard screen display 1100 includes controls 1110, including an ontology-enhanced display control 1120 that activates an ontology-enhanced dashboard screen display, as shown below in FIGS. 12-17. The dashboard screen display 1100 also includes a data display window 1130 and an artificial intelligence (AI) chat window 1140.

FIG. 12 is an example ontology-enhanced supervisor dashboard screen display 1200 for an ontology-based insight generation system, in accordance with at least one embodiment of the present disclosure. Visible are a search parameters area 1210, a search results area 1220, and an LLM analysis and summary area 1230.

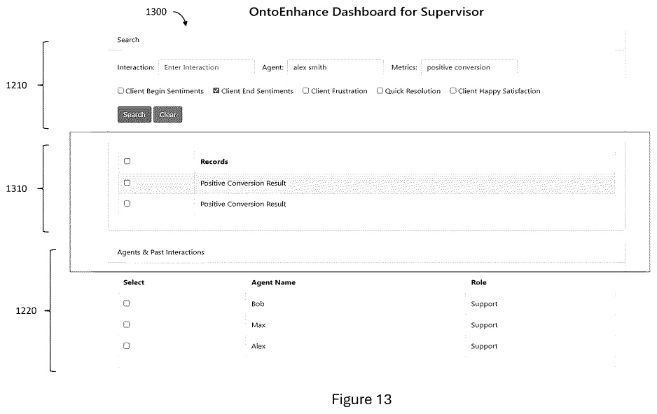

This dashboard 1200 allows to model a domain through entities, relationships, and axioms within the contact center ontology, such that contact center professionals (e.g., supervisors), can make data-driven decisions to enhance operational efficiency and performance. In one example use case, the supervisor can search based on past interactions, agents, and metrics displayed. For instance, if a supervisor wants to check whether agent Alex can convert negative interactions into positive ones, he can directly verify this by selecting items on the dashboard screen display 1200, clicking on the search button, and reviewing the result, as shown below in FIGS. 13-17.

FIG. 13 is an example ontology-enhanced supervisor dashboard screen display 1300 for an ontology-based insight generation system, in accordance with at least one embodiment of the present disclosure. Visible are a search parameters area 1210, a search results area 1220, and a records area 1310. In the example shown in FIG. 13, the supervisor has selected to search for positive conversions and client end sentiments for agent Alex. Here, the supervisor can review the number of interactions an agent (e.g., Alex) participated in, and their performance. For example, a supervisor can see that the agent was involved in two interactions, demonstrating traits such as clarity of understanding and empathy. Supervisors can analyze the performance of agents based on different channel types used in the interactions. For example, if the agent's performance in clarity of understanding was higher when the channel was “call” in interaction 1 compared to “chat” in interaction 2, this information helps supervisors determine that the agent performs better in voice-based interactions.

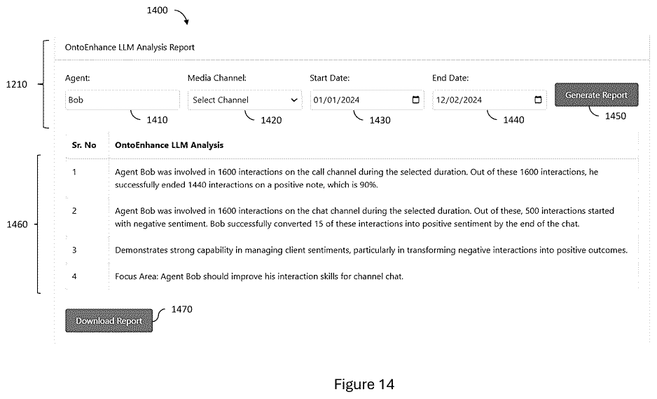

FIG. 14 is an example ontology-enhanced supervisor dashboard screen display 1400 for an ontology-based insight generation system, in accordance with at least one embodiment of the present disclosure. Visible are a search parameters area 1210 and an LLM analysis and summary area 1460. The search parameters area 1210 includes an agent selection menu 1410, a channel selection menu 1420, a start date selection menu 1430, and end date selection menu, and a “generate report” button. The LLM analysis and summary area 1460 includes a “download report” button 1470. In the example shown in FIG. 14, the supervisor has elected to review agent Bob's report and access his performance for this year.

Here is an example output: Out of 1600 interactions, he successfully concluded (90%) on a positive note. This showcases his strong ability to manage client sentiments, especially in turning negative interactions into positive outcomes. Focus Area: Agent Bob should improve his interaction skills for channel chat. As can be seen, the LLM summary provides succinct, actionable insights to the supervisor, thus facilitating training and scheduling for the agents.

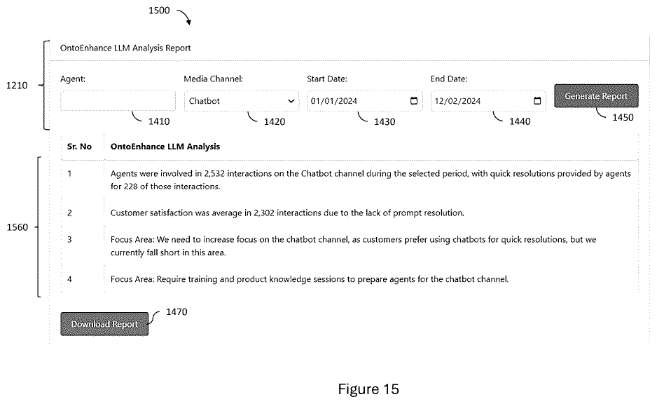

FIG. 15 is an example ontology-enhanced supervisor dashboard screen display 1500 for an ontology-based insight generation system, in accordance with at least one embodiment of the present disclosure. Visible are a search parameters area 1210 and an LLM analysis and summary area 1460. The search parameters area 1210 includes an agent selection menu 1410, a channel selection menu 1420, a start date selection menu 1430, and end date selection menu, and a “generate report” button. The LLM analysis and summary area 1460 includes a “download report” button 1470.

In the example shown in FIG. 15, the supervisor has elected to review performance by individual channel type, specifically when the channel is chatbot. In this example, agents were involved in 2,532 interactions but the quick resolutions rate is very low—just 228 out of 2,532, or 9.0%. As a result, customer satisfaction was average in 2,302 interactions due to the lack of prompt resolution. Thus, one focus area is to increase focus on the chatbot channel, as customers prefer using chatbots for quick resolutions, where the agents are currently falling short. Another focus area is to require training and product knowledge sessions to prepare agents for the chatbot channel. In this way, supervisors can utilize past interactions data for informed decision making.

FIG. 16 is an example ontology-enhanced supervisor dashboard screen display 1600 for an ontology-based insight generation system, in accordance with at least one embodiment of the present disclosure. Visible is a graphical representation 1610 of an OWL file output by the LLM, along with a text summary 1620 of the OWL file. In the example shown in FIG. 16, the graphical representation 1610 includes an agent name 1630, an interaction number 1640, a customer beginning sentiment 1650, and a customer ending sentiment 1660.

Here, the supervisor can see that agent Alex was involved in interaction 1 and was able to convert a negative interaction to a positive one. The reports also highlight how well agent Alex managed client sentiments. It also shows how he could intervene when interactions take a negative turn or when the customer is dissatisfied. Supervisors can also search and retrieve details based on various metrics, such as identifying agents who demonstrate strong clarity of understanding, or have high customer relationship scores, or excel in managing client frustration and providing resolutions, etc.

FIG. 17 is an example ontology-enhanced supervisor dashboard screen display 1700 for an ontology-based insight generation system, in accordance with at least one embodiment of the present disclosure. A graphical representation 1710 is shown of an OWL file output by the LLM, along with a text summary 1620 of the OWL file. In the example shown in FIG. 17, the graphical representation 1610 includes a first interaction 1710a and a second interaction 1710b. The first interaction 1710a includes an interaction number 1640a, a beginning sentiment 1660, and ending sentiment 1650, a channel type 1720a, and a customer frustration 1730. The second interaction includes an interaction number 1640b, a customer satisfaction 1740, a channel type 1720b, and a resolution 1740.

By examining all interactions an agent was involved in, the supervisor can identify strengths and weaknesses, as well as suggested focus areas based on business needs.

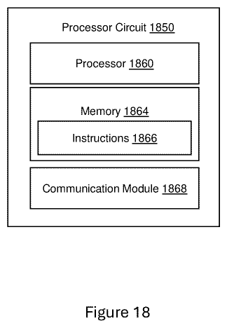

FIG. 18 is a schematic diagram of a processor circuit 1850, in accordance with at least one embodiment of the present disclosure. The processor circuit 1850 may be implemented in the system 100, 200, 300, or other devices or workstations (e.g., third-party workstations, network routers, etc.), or on a cloud processor or other remote processing unit, as necessary to implement the method. As shown, the processor circuit 1850 may include a processor 1860, a memory 1864, and a communication module 1868. These elements may be in direct or indirect communication with each other, for example via one or more buses.

The processor 1860 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 1860 may also comprise another hardware device, a firmware device, or any combination thereof configured to perform the operations described herein. The processor 1860 may also be implemented as a combination of computing devices, e.g., a combination of a DSP and a microprocessor, a plurality of microprocessors, one or more microprocessors in conjunction with a DSP core, or any other such configuration.

The memory 1864 may include a cache memory (e.g., a cache memory of the processor 1860), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 1864 includes a non-transitory computer-readable medium. The memory 1864 may store instructions 1866. The instructions 1866 may include instructions that, when executed by the processor 1860, cause the processor 1860 to perform the operations described herein. Instructions 1866 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 1868 can include any electronic circuitry and/or logic circuitry to facilitate direct or indirect communication of data between the processor circuit 1850, and other processors or devices. In that regard, the communication module 1868 can be an input/output (I/O) device. In some instances, the communication module 1868 facilitates direct or indirect communication between various elements of the processor circuit 1850 and/or the system 100, 200, or 300. The communication module 1868 may communicate within the processor circuit 1850 through numerous methods or protocols. Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, etc.) may be accomplished using any suitable wireless or wired communication technology, such as a cable interface such as a universal serial bus (USB), micro USB, Lightning, or Fire Wire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

As will be readily appreciated by those having ordinary skill in the art after becoming familiar with the teachings herein, the ontology-based insight generation system advantageously sifts through large amounts of unstructured data to output concise, actionable insights for the call center supervisor. These insights may for example be used for training, workforce management, and scheduling.

A number of variations are possible on the examples and embodiments described above. For example, different classes, properties, thresholds, traits, performance categories, metrics, labels, relationships may be used than are described herein. Ontology Web Language may be replaced with a different or generic ontology management or markup language. The technology described herein may be applied to contact center of different sorts, including but not limited to tech support centers, customer support centers, emergency services, and otherwise.

The logical operations making up the embodiments of the technology described herein are referred to variously as operations, steps, objects, elements, components, blocks, or modules. Furthermore, it should be understood that these may occur, or be performed or arranged, in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the ontology-based insight generation system. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the ontology-based insight generation system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A system adapted to automatically provide ontology-based insights, the system comprising:
a contact center supervisor computing device having a processor and a non-transitory computer-readable medium operably coupled thereto, the contact center supervisor computing device comprising a graphical user interface (GUI), the computer-readable medium comprising a plurality of instructions stored in association therewith that are accessible to, and executable by, the processor, to perform operations which comprise:
over a first period of time, with a database, receiving a plurality of interactions between a plurality of agents and a plurality of customers, each interaction comprising a channel of a plurality of channels;
converting the plurality of interactions to a first Ontology Web Language (OWL) file;
with the first OWL file, training a large language model (LLM) to extract a plurality of metrics related to the interactions and a plurality of metrics related to the agents;
with the GUI, at a time later than the first period of time, receiving a user input;
with a parser, based on the user input and the plurality of interactions, generating a second OWL file;
with a visual representation module, graphically representing the second OWL file via the GUI; or
with the LLM, generating a text summary of the second OWL file; and
presenting the text summary to the user via the GUI.

2. The system of claim 1, wherein the user input comprises a request for information about a particular agent of the plurality of agents.

3. The system of claim 1, wherein the user input comprises a request for information about a particular interaction of the plurality of interactions.

4. The system of claim 1, wherein the user input comprises a request for information about a particular metric related to the interactions.

5. The system of claim 1, wherein the user input comprises a request for information about a particular metric related to the agents.

6. The system of claim 1, wherein the metrics related to the interactions include at least one of a customer beginning sentiment, a customer ending sentiment, a customer frustration, a resolution, a resolution speed, or a customer satisfaction.

7. The system of claim 1, wherein the metrics related to the agents include at least one of agent skills, agent wait times, or agent metrics.

8. The system of claim 1, wherein if a metric of the plurality of metrics related to an agent of the plurality of agents is below a threshold value for a particular channel of the plurality of channels:
providing feedback or training to the agent via the LLM and the GUI; or
limiting future interactions for that channel to that agent.

9. The system of claim 1, wherein if a metric of the plurality of metrics related to an agent of the plurality of agents is equal to or above a threshold value for a particular channel of the plurality of channels, assigning future interactions for that channel to the agent.

10. The system of claim 1, wherein the text summary or the graphically represented second OWL file includes a prediction of agent performance.

11. A computer-implemented method, comprising:
with contact center supervisor computing device having a processor and a non-transitory computer-readable medium operably coupled thereto, the contact center supervisor computing device comprising a graphical user interface (GUI), the computer-readable medium comprising a plurality of instructions stored in association therewith that are accessible to, and executable by, the processor:
over a first period of time, with a database, receiving a plurality of interactions between a plurality of agents and a plurality of customers, each interaction comprising a channel of a plurality of channels;
converting the plurality of interactions to a first Ontology Web Language (OWL) file;
with the first OWL file, training a large language model (LLM) to extract a plurality of metrics related to the interactions and a plurality of metrics related to the agents;
with the GUI, at a time later than the first period of time, receiving a user input;
with a parser, based on the user input and the plurality of interactions, generating a second OWL file;
with a visual representation module, graphically representing the second OWL file via the GUI; or
with the LLM, generating a text summary of the second OWL file; and
presenting the text summary to the user via the GUI.

12. The method of claim 11, wherein the user input comprises a request for information about a particular agent of the plurality of agents.

13. The method of claim 11, wherein the user input comprises a request for information about a particular interaction of the plurality of interactions.

14. The method of claim 11, wherein the user input comprises a request for information about a particular metric related to the interactions.

15. The method of claim 11, wherein the user input comprises a request for information about a particular metric related to the agents.

16. The method of claim 11, wherein the metrics related to the interactions include at least one of a customer beginning sentiment, a customer ending sentiment, a customer frustration, a resolution, a resolution speed, or a customer satisfaction.

17. The method of claim 11, wherein the metrics related to the agents include at least one of agent skills, agent wait times, or agent metrics.

18. The method of claim 11, wherein if a metric of the plurality of metrics related to an agent of the plurality of agents is below a threshold value for a particular channel of the plurality of channels:
providing feedback or training to the agent via the LLM and the GUI; or
limiting future interactions for that channel to that agent.

19. The method of claim 11, wherein if a metric of the plurality of metrics related to an agent of the plurality of agents is equal to or above a threshold value for a particular channel of the plurality of channels, assigning future interactions for that channel to the agent.

20. The method of claim 11, wherein the text summary or the graphically represented second OWL file includes a prediction of agent performance.
